(19) United States
(12) Patent Application Publication
(10) Pub. No.: US 2019/0297570 A1
(43) Pub. Date: Sep. 26, 2019

(54) POWER SAVING TECHNIQUES FOR COLLECTING IoT DATA FROM DEVICES CONNECTED TO SENSORS THROUGH AN EXTERNAL MICRO-CONTROLLER

(71) Applicant: QUALCOMM Incorporated, San Diego, CA (US)

(72) Inventor: Murali BHARADWAJ, San Diego, CA (US)

(21) Appl. No.: 16/143,277

(22) Filed: Sep. 26, 2018

Related U.S. Application Data
(60) Provisional application No. 62/646,361, filed on Mar. 21, 2018.

(51) Int. Cl. H04W 52/02; H04Q 9/00; H04W 4/38

(52) U.S. Cl. CPC H04W 52/0209; H04Q 9/00; H04Q 2209/40; H04Q 2209/883; H04Q 2209/826; H04W 4/38

(57) ABSTRACT

Aspects of the present disclosure may help reduce power consumption by coordinating both the sampling of sensor data and bundled reporting of sensor data with one or more reduced power state (e.g., power saving mode (PSM) and/or extended/enhanced discontinuous reception (eDRX)) on periods of the UE.

### CLAIM OF PRIORITY UNDER 35 U.S.C. § 119

This application claims the benefit of U.S. Provisional Patent Application Ser. No. 62/646,361, filed Mar. 21, 2018, which is herein incorporated by reference in its entirety.

### FIELD OF THE DISCLOSURE

Aspects of the present disclosure generally relate to wireless communication and, more particularly, to saving power in sensor reporting applications.

### DESCRIPTION OF RELATED ART

Wireless communication systems are widely deployed to provide various types of communication content such as voice, data, and so on. In one example application of wireless communications, Internet of Things (IoT) devices may be used to collect sensor data.

Typical IoT devices collecting data based on sensors connected to them are slowly seeing an increased popularity in our day-day lives. Some examples are alarm panels, soil/water level indicators, rain gauges monitoring weather, water/gas meters and so on. Some of the data monitored from these sensors and collected in the IoT cloud help address issues remotely and in some cases (depending on the situation and data collected) address emergency situations.

A key aspect of collecting a wide range of data with a high frequency has an adverse impact on the battery life of the device. So, it is a must to ensure that while collecting key sensor data in a timely manner is of utmost importance, it is equally important to collect the data in a smart manner so as to improve the overall battery lifetime of these remotely installed devices

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “DETAILED DESCRIPTION” one will understand how the features of this disclosure provide advantages that include improved communications between base stations and terminals in a wireless network.

Certain aspects of the present disclosure generally relate to a method for wireless communications by a user equipment (UE). The method generally includes sampling data from a plurality of sensors, bundling reporting of data from the plurality of sensors by adjusting parameters, for each sensor, based on which the UE reports corresponding sensor data, and coordinating both the bundling and the sampling with one or more reduced power state on periods of the UE.

Certain aspects of the present disclosure generally relate to a method for wireless communications by a network entity. The method generally includes identifying a first set of sensors for which a user equipment (UE) is allowed to adjust parameters based on which the UE reports corresponding sensor data and configuring the UE for sampling data from a plurality of sensors including the first set of sensors, wherein the configuring includes providing information to the UE regarding the first set of sensors.

Aspects generally include methods, apparatus, systems, computer program products, and processing systems, as substantially described herein with reference to and as illustrated by the accompanying drawings.

Other aspects, features, and embodiments of the present invention will become apparent to those of ordinary skill in the art, upon reviewing the following description of specific, exemplary aspects of the present invention in conjunction with the accompanying figures. While features of the present disclosure may be discussed relative to certain aspects and figures below, all embodiments of the present disclosure can include one or more of the advantageous features discussed herein. In other words, while one or more aspects may be discussed as having certain advantageous features, one or more of such features may also be used in accordance with the various aspects of the disclosure discussed herein. In similar fashion, while exemplary aspects may be discussed below as device, system, or method aspects it should be understood that such exemplary aspects can be implemented in various devices, systems, and methods.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. The appended drawings illustrate only certain typical aspects of this disclosure, however, and are therefore not to be considered limiting of its scope, for the description may admit to other equally effective aspects.

FIG. 1 illustrates an example of a wireless communication network, in accordance with certain aspects of the present disclosure.

FIG. 2 shows a block diagram conceptually illustrating an example of a base station (BS) in communication with a user equipment (UE) in a wireless communications network, in accordance with certain aspects of the present disclosure.

FIG. 3 is a block diagram conceptually illustrating an example of a frame structure in a wireless communications network, in accordance with certain aspects of the present disclosure.

FIG. 4 is a block diagram conceptually illustrating two exemplary subframe formats with the normal cyclic prefix.

FIG. 5 illustrates various components that may be utilized in a wireless device, in accordance with certain aspects of the present disclosure.

FIG. 6 illustrates an example logical architecture of a distributed radio access network (RAN), in accordance with certain aspects of the present disclosure.

FIG. 7 illustrates an example physical architecture of a distributed RAN, in accordance with certain aspects of the present disclosure.

FIG. 8 is a diagram illustrating an example of a downlink (DL)-centric subframe, in accordance with certain aspects of the present disclosure.

FIG. 9 is a diagram illustrating an example of an uplink (UL)-centric subframe, in accordance with certain aspects of the present disclosure.

FIG. 10 illustrates an example architecture for sampling and reporting sensor data, in accordance with certain aspects of the present disclosure.

FIG. 11 illustrates example operations performed by a UE for wireless communications, in accordance with certain aspects of the present disclosure.

FIG. 12 illustrates example operations performed by a network entity for wireless communications, in accordance with certain aspects of the present disclosure.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Aspects of the present disclosure provide techniques that may help reduce power in data sensing applications, such as Internet of Things (IoT) sensor monitoring. Power may be reduced by coordinating sensor data sampling and reporting with reduced power state on periods.

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as universal terrestrial radio access (UTRA), cdma2000, etc. UTRA includes wideband CDMA (WCDMA), time division synchronous CDMA (TD-SCDMA), and other variants of CDMA. cdma2000 covers IS-2000, IS-95 and IS-856 standards. A TDMA network may implement a radio technology such as global system for mobile communications (GSM). An OFDMA network may implement a radio technology such as evolved UTRA (E-UTRA), ultra mobile broadband (UMB), IEEE 802.11 (Wi-Fi), IEEE 802.16 (WiMAX), IEEE 802.20, Flash-OFDM®, etc. UTRA and E-UTRA are part of universal mobile telecommunication system (UMTS). 3GPP Long Term Evolution (LTE) and LTE-Advanced (LTE-A), in both frequency division duplex (FDD) and time division duplex (TDD), are new releases of UMTS that use E-UTRA, which employs OFDMA on the downlink and SC-FDMA on the uplink. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE/LTE-Advanced, and LTE/LTE-Advanced terminology is used in much of the description below. LTE and LTE-A are referred to generally as LTE.

Some examples of UEs may include cellular phones, smart phones, personal digital assistants (PDAs), wireless modems, handheld devices, tablets, laptop computers, netbooks, smartbooks, ultrabooks, medical device or equipment, biometric sensors/devices, wearable devices (smart watches, smart clothing, smart glasses, virtual reality goggles, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a positioning system device (e.g., satellite positioning system (e.g., Global Positioning System (GPS), Beidou) device, terrestrial position location device) or any other suitable device that is configured to communicate via a wireless or wired medium. Some UEs may be considered evolved or enhanced machine-type communication (eMTC) UEs. MTC and eMTC UEs include, for example, robots, drones, remote devices, such as sensors, meters, monitors, location tags, etc., that may communicate with a base station, another device (e.g., remote device), or some other entity. A wireless node may provide, for example, connectivity for or to a network (e.g., a wide area network such as Internet or a cellular network) via a wired or wireless communication link.

It is noted that while aspects may be described herein using terminology commonly associated with 3G and/or 4G wireless technologies, aspects of the present disclosure can be applied in other generation-based communication systems, such as 5G and later.

### EXAMPLE WIRELESS COMMUNICATIONS NETWORK

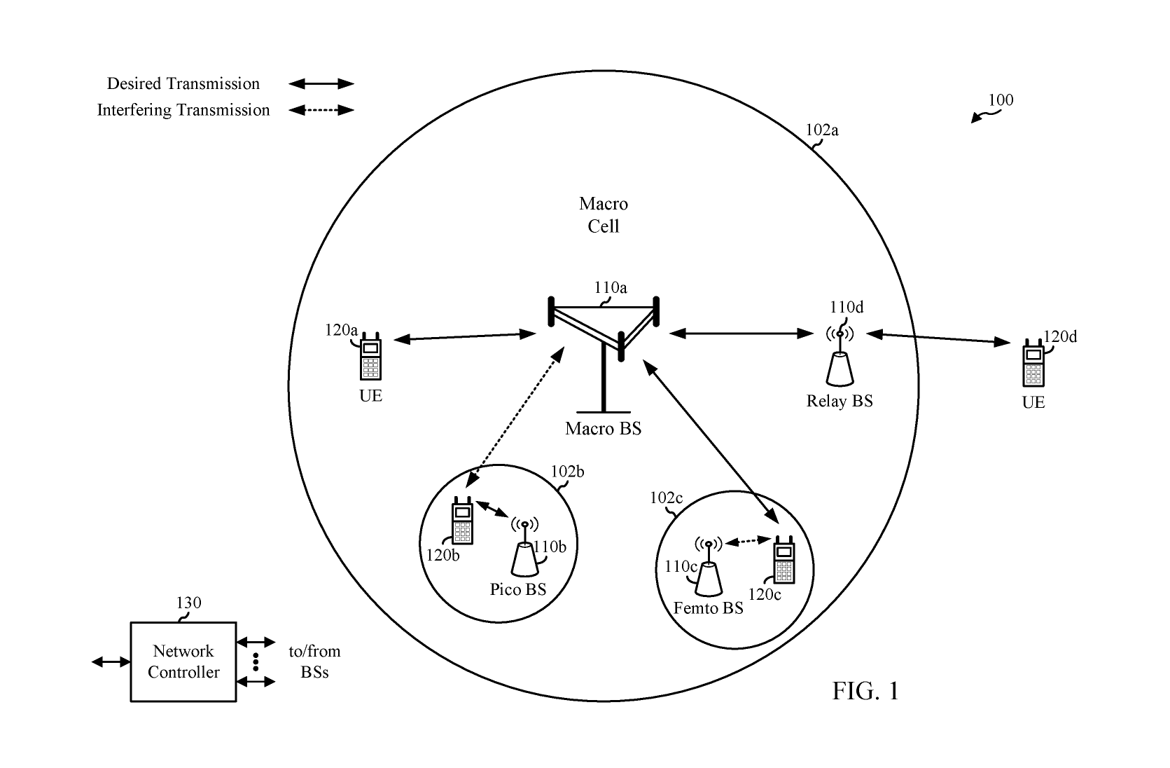

FIG. 1 illustrates an example wireless communication network 100, in which aspects of the present disclosure may be practiced. For example, one or more UEs 120 may be configured to determine times to be awake to receive or discover Multimedia Broadcast Multicast Services (MBMS) user services in accordance with aspects of the present disclosure.

The wireless communication network 100 may be an LTE network or some other wireless network. Wireless communication network 100 may include a number of base stations (BSs) 110 and other network entities. A BS is an entity that communicates with user equipments (UEs) and may also be referred to as a Node B, evolved NB (eNB), a next generation NB (gNB), an access point (AP), new radio (NR) BS, 5G BS, etc. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or other types of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station” and “cell” may be used interchangeably herein.

Wireless communication network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communication between BS 110a and UE 120d. A relay station may also be referred to as a relay BS, a relay, etc.

Wireless communication network 100 may be a heterogeneous network that includes BSs of different types, e.g., macro BSs, pico BSs, femto BSs, relay BSs, etc. These different types of BSs may have different transmit power levels, different coverage areas, and different impact on interference in wireless communication network 100. For example, macro BSs may have a high transmit power level (e.g., 5 to 40 Watts) whereas pico BSs, femto BSs, and relay BSs may have lower transmit power levels (e.g., 0.1 to 2 Watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless communication network 100, and each UE may be stationary or mobile. A UE may also be referred to as an access terminal, a terminal, a mobile station, a subscriber unit, a station, etc. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, etc. In FIG. 1, a solid line with double arrows indicates desired transmissions between a UE and a serving BS, which is a BS designated to serve the UE on the downlink and/or uplink. A dashed line with double arrows indicates potentially interfering transmissions between a UE and a BS.

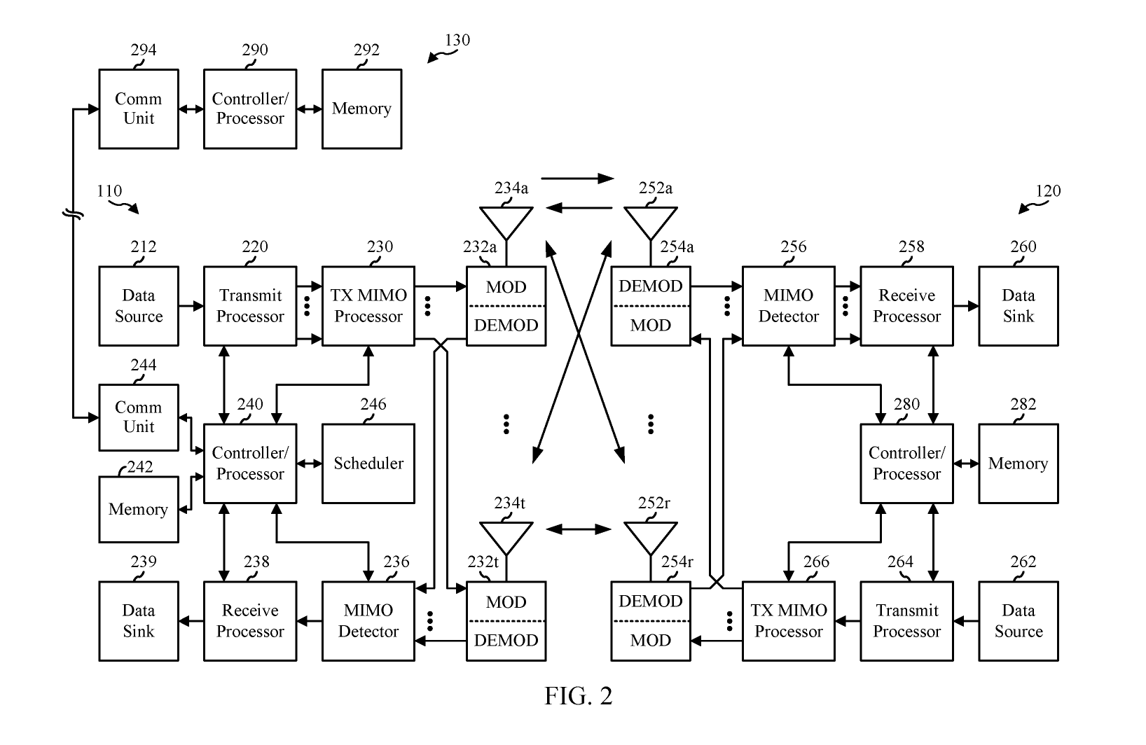

FIG. 2 shows a block diagram of a design of BS 110 and UE 120, which may be one of the BSs and one of the UEs in FIG. 1. BS 110 may be equipped with T antennas 234a through 234t, and UE 120 may be equipped with R antennas 252a through 252r, where in general T≥1 and R≥1.

At BS 110, a transmit processor 220 may receive data from a data source 212 for one or more UEs, select one or more modulation and coding schemes (MCS) for each UE based on channel quality information (CQI) received from the UE, process (e.g., encode and modulate) the data for each UE based on the MCS(s) selected for the UE, and provide data symbols for all UEs. Transmit processor 220 may also process system information (e.g., for static resource partitioning information (SRPI), etc.) and control information (e.g., CQI requests, grants, upper layer signaling, etc.) and provide overhead symbols and control symbols. Processor 220 may also generate reference symbols for reference signals (e.g., the CRS) and synchronization signals (e.g., the primary synchronization signal (PSS) and the secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM, etc.) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from BS 110 and/or other BSs and may provide received signals to demodulators (DEMODs) 254a through 254r, respectively. Each demodulator 254 may condition (e.g., filter, amplify, downconvert, and digitize) its received signal to obtain input samples. Each demodulator 254 may further process the input samples (e.g., for OFDM, etc.) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. A channel processor may determine reference signal receive power (RSRP), receive signal strength indicator (RSSI), receive signal receive quality (RSRQ), CQI, interference feedback Rnn, etc.

On the uplink, at UE 120, a transmit processor 264 may receive and process data from a data source 262 and control information (e.g., for reports comprising RSRP, RSSI, RSRQ, CQI, etc.) from controller/processor 280. Processor 264 may also generate reference symbols for one or more reference signals. The symbols from transmit processor 264 may be precoded by a TX MIMO processor 266 if applicable, further processed by modulators 254a through 254r (e.g., for SC-FDM, OFDM, etc.), and transmitted to BS 110. At BS 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Processor 238 may provide the decoded data to a data sink 239 and the decoded control information to controller/processor 240. BS 110 may include communication unit 244 and communicate to network controller 130 via communication unit 244. Network controller 130 may include communication unit 294, controller/processor 290, and memory 292.

Controller/processor 280 may direct the operation of UE 120 to perform techniques presented herein for determining independent wakeups for to receive or discover broadcast data (e.g., in accordance with the operations shown in FIG. 11).

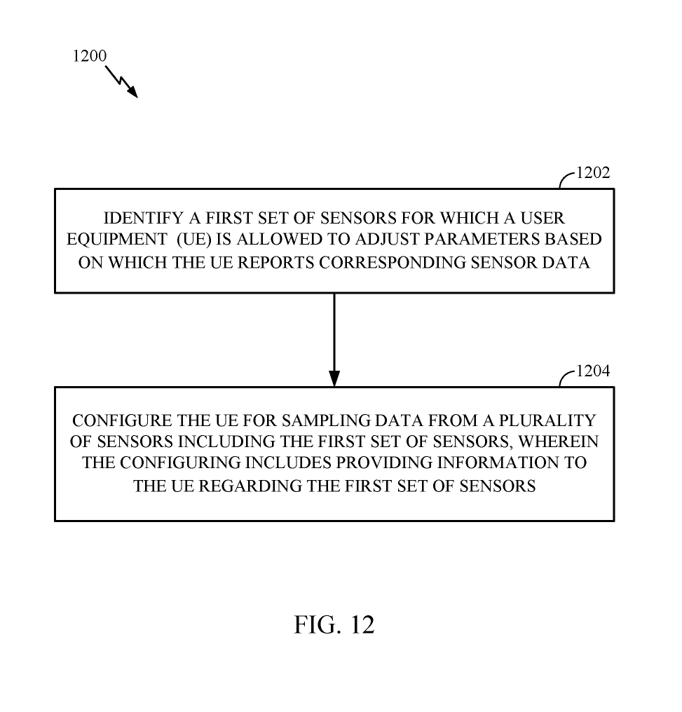

Controller/processor 240 may direct the operation of BS 110 to perform techniques presented herein for determining independent wakeups for to receive or discover broadcast data (e.g., in accordance with the operations shown in FIG. 12).

Memories 242 and 282 may store data and program codes for BS 110 and UE 120, respectively. A scheduler 246 may schedule UEs for data transmission on the downlink and/or uplink.

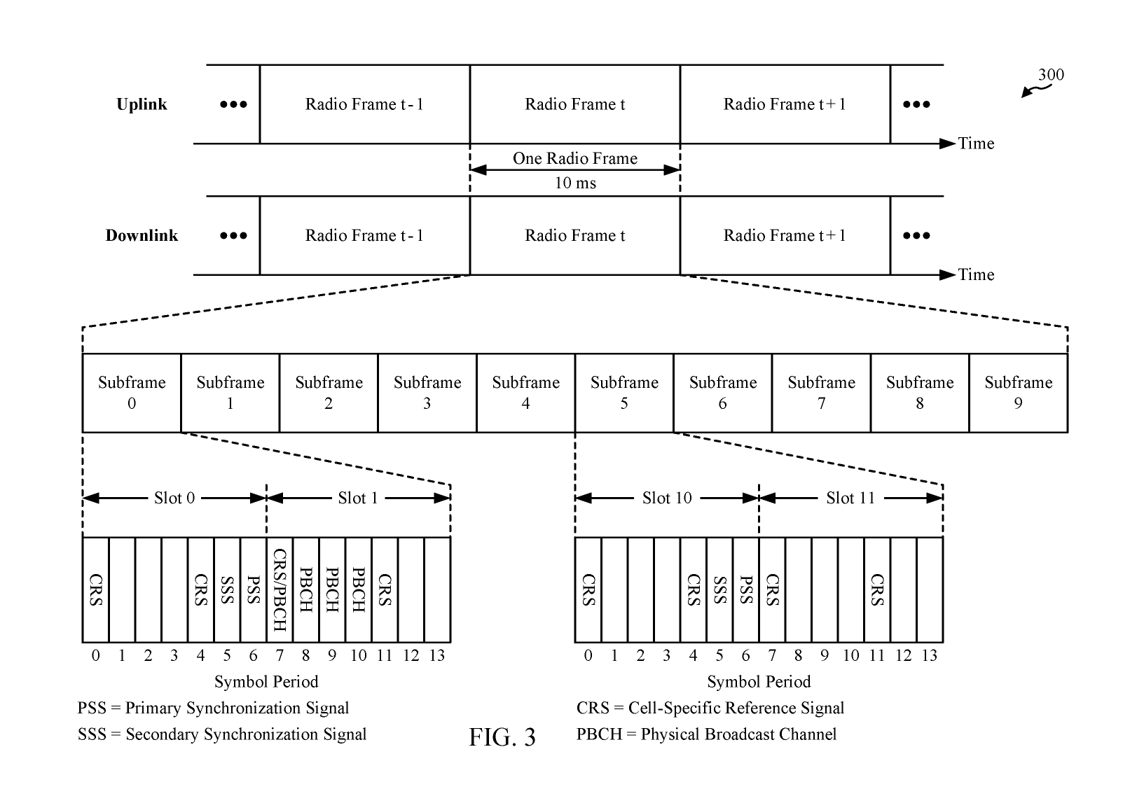

FIG. 3 shows an exemplary frame structure 300 for frequency division duplexing (FDD) in LTE. The transmission timeline for each of the downlink and uplink may be partitioned into units of radio frames. Each radio frame may have a predetermined duration (e.g., 10 milliseconds (ms)) and may be partitioned into 10 subframes (e.g., 1 ms subframes) with indices of 0 through 9. Each subframe may include two slots. Each radio frame may thus include 20 slots with indices of 0 through 19. Each slot may include L symbol periods, e.g., seven symbol periods for a normal cyclic prefix (as shown in FIG. 3) or six symbol periods for an extended cyclic prefix. The 2L symbol periods in each subframe may be assigned indices of 0 through 2L-1.

In LTE, a BS may transmit a PSS and a SSS on the downlink in the center of the system bandwidth for each cell supported by the BS. The PSS and SSS may be transmitted in symbol periods 6 and 5, respectively, in subframes 0 and 5 of each radio frame with the normal cyclic prefix, as shown in FIG. 3. The PSS and SSS may be used by UEs for cell search and acquisition. The BS may transmit a cell-specific reference signal (CRS) across the system bandwidth for each cell supported by the BS. The CRS may be transmitted in certain symbol periods of each subframe and may be used by the UEs to perform channel estimation, channel quality measurement, and/or other functions. The BS may also transmit a physical broadcast channel (PBCH) in symbol periods 0 to 3 in slot 1 of certain radio frames. The PBCH may carry some system information. The BS may transmit other system information such as system information blocks (SIBs) on a physical downlink shared channel (PDSCH) in certain subframes. The BS may transmit control information/data on a physical downlink control channel (PDCCH) in the first B symbol periods of a subframe, where B may be configurable for each subframe. The BS may transmit traffic data and/or other data on the PDSCH in the remaining symbol periods of each subframe. In aspects, a serving cell and one or more neighbor cells are synchronous, such that SSS for the serving and the one or more neighbor cells may interfere.

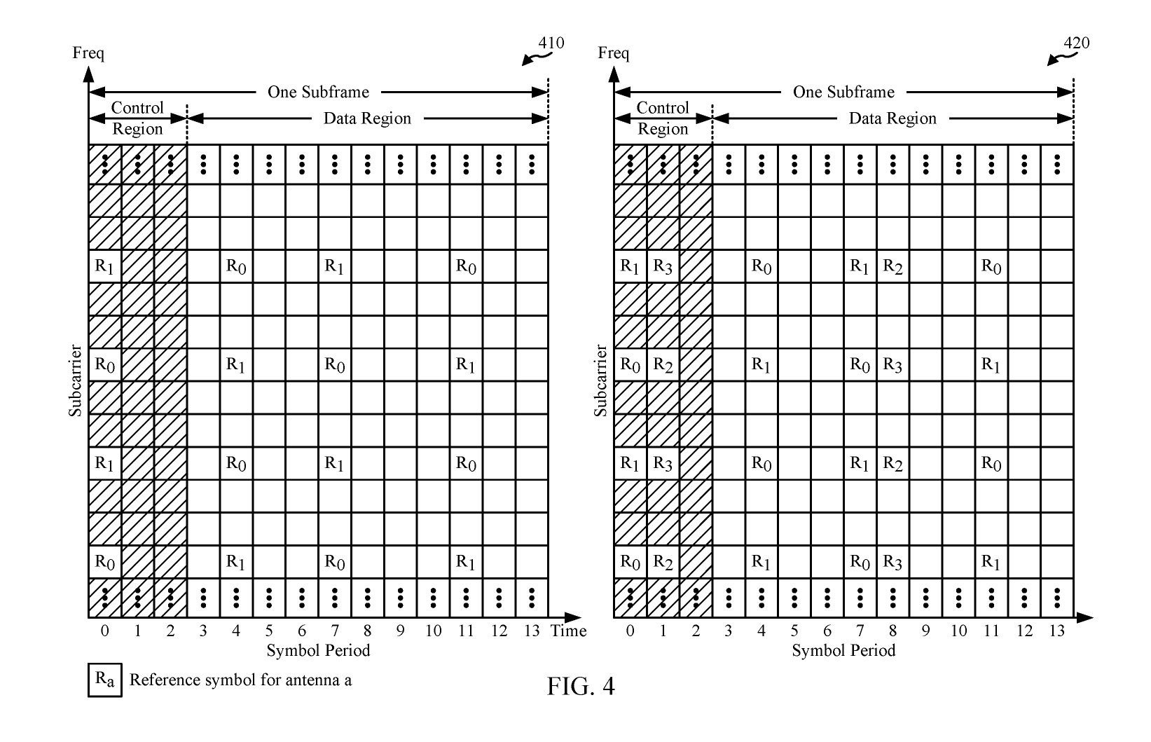

FIG. 4 shows two exemplary subframe formats 410 and 420 with the normal cyclic prefix. The available time frequency resources may be partitioned into resource blocks (RBs). Each RB may cover 12 subcarriers in one slot and may include a number of resource elements (REs). Each RE may cover one subcarrier in one symbol period and may be used to send one modulation symbol, which may be a real or complex value.

Subframe format 410 may be used for two antennas. A cell-specific reference signal (CRS) may be transmitted from antennas 0 and 1 in symbol periods 0, 4, 7 and 11. A reference signal is a signal that is known a priori by a transmitter and a receiver and may also be referred to as pilot. A CRS is a reference signal that is specific for a cell, for example, generated based on a cell identity (ID). In FIG. 4, for a given RE with label Ra, a modulation symbol may be transmitted on that RE from antenna a, and no modulation symbols may be transmitted on that resource element from other antennas. Subframe format 420 may be used with four antennas. A CRS may be transmitted from antennas 0 and 1 in symbol periods 0, 4, 7 and 11 and from antennas 2 and 3 in symbol periods 1 and 8. For both subframe formats 410 and 420, a CRS may be transmitted on evenly spaced subcarriers, which may be determined based on cell ID. CRSs may be transmitted on the same or different subcarriers, depending on their cell IDs. For both subframe formats 410 and 420, resource elements not used for the CRS may be used to transmit data (e.g., traffic data, control data, and/or other data).

The PSS, SSS, CRS and PBCH in LTE are described in 3GPP TS 36.211, entitled “Evolved Universal Terrestrial Radio Access (E-UTRA); Physical Channels and Modulation,” which is publicly available.

An interlace structure may be used for each of the downlink and uplink for FDD in LTE. For example, Q interlaces with indices of 0 through Q−1 may be defined, where Q may be equal to 4, 6, 8, 10, or some other value. Each interlace may include subframes that are spaced apart by Q frames. In particular, interlace q may include subframes q, q+Q, q+2Q, etc., where q∈{0, . . . , Q−1}.

The wireless communication network may support hybrid automatic retransmission request (HARQ) for data transmission on the downlink and uplink. For HARQ, a transmitter (e.g., a BS) may send one or more transmissions of a packet until the packet is decoded correctly by a receiver (e.g., a UE) or some other termination condition is encountered. For synchronous HARQ, all transmissions of the packet may be sent in subframes of a single interlace. For asynchronous HARQ, each transmission of the packet may be sent in any subframe.

A UE may be located within the coverage of multiple BSs. One of these BSs may be selected to serve the UE. The serving BS may be selected based on various criteria such as received signal strength, received signal quality, pathloss, etc. Received signal quality may be quantified by a signal-to-noise-and-interference ratio (SINR), or a reference signal received quality (RSRQ), or some other metric. The UE may operate in a dominant interference scenario in which the UE may observe high interference from one or more interfering BSs.

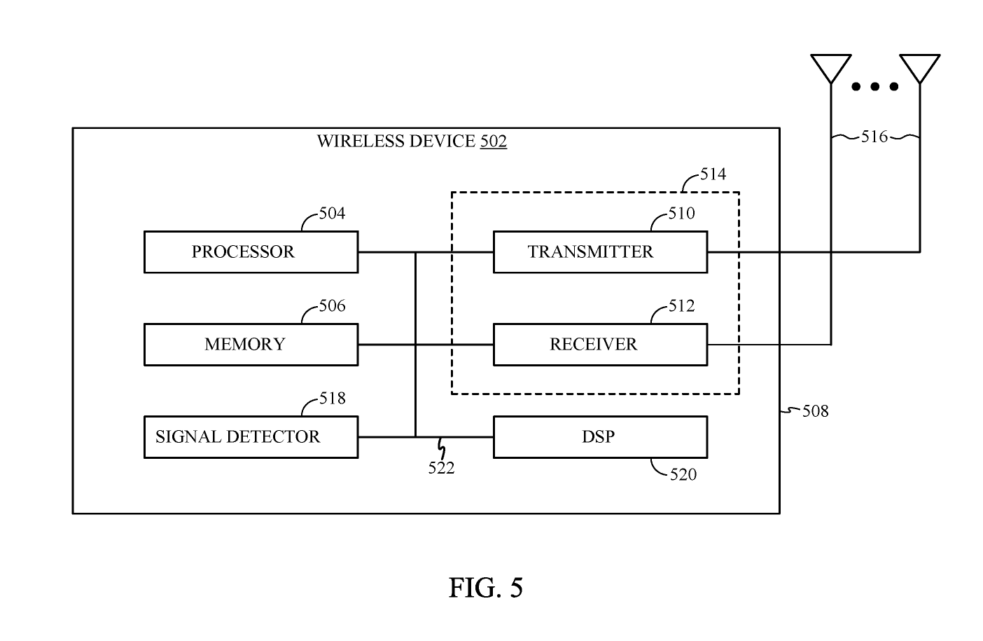

FIG. 5 illustrates various components that may be utilized in a wireless device 502 that may be employed within the wireless communication system 100 illustrated in FIG. 1. The wireless device 502 is an example of a device that may be configured to implement the various methods described herein. The wireless device 502 may be any of the wireless nodes (e.g., UEs 120). For example, the wireless device 502 may be configured to perform operations and techniques illustrated in FIG. 11 or FIG. 12 as well as other operations described herein.

The wireless device 502 may include a processor 504 that controls operation of the wireless device 502. The processor 504 may also be referred to as a central processing unit (CPU). Memory 506, which may include both read-only memory (ROM) and random access memory (RAM), provides instructions and data to the processor 504. A portion of the memory 506 may also include non-volatile random access memory (NVRAM). The processor 504 typically performs logical and arithmetic operations based on program instructions stored within the memory 506. The instructions in the memory 506 may be executable to implement the methods described herein. Some non-limiting examples of the processor 504 may include Snapdragon processor, application specific integrated circuits (ASICs), programmable logic, etc.

The wireless device 502 may also include a housing 508 that may include a transmitter 510 and a receiver 512 to allow transmission and reception of data between the wireless device 502 and a remote location. The transmitter 510 and receiver 512 may be combined into a transceiver 514. A single transmit antenna or a plurality of transmit antennas 516 may be attached to the housing 508 and electrically coupled to the transceiver 514. The wireless device 502 may also include (not shown) multiple transmitters, multiple receivers, and multiple transceivers. The wireless device 502 can also include wireless battery charging equipment.

The wireless device 502 may also include a signal detector 518 that may be used in an effort to detect and quantify the level of signals received by the transceiver 514. The signal detector 518 may detect such signals as total energy, energy per subcarrier per symbol, power spectral density and other signals. The wireless device 302 may also include a digital signal processor (DSP) 520 for use in processing signals.

The various components of the wireless device 502 may be coupled together by a bus system 522, which may include a power bus, a control signal bus, and a status signal bus in addition to a data bus. The processor 504 may be configured to access instructions stored in the memory 506 to perform beam refinement with aspects of the present disclosure discussed below.

### Example NR/5G RAN Architecture

While aspects of the examples described herein may be associated with LTE technologies, aspects of the present disclosure may be applicable with other wireless communications systems, such as NR or 5G technologies.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a CP on the uplink and downlink and include support for half-duplex operation using TDD. NR may include Enhanced Mobile Broadband (eMBB) service targeting wide bandwidth (e.g. 80 MHz beyond), millimeter wave (mmW) targeting high carrier frequency (e.g. 27 GHz or beyond), massive MTC (mMTC) targeting non-backward compatible MTC techniques, and/or mission critical targeting ultra-reliable low-latency communications (URLLC) service.

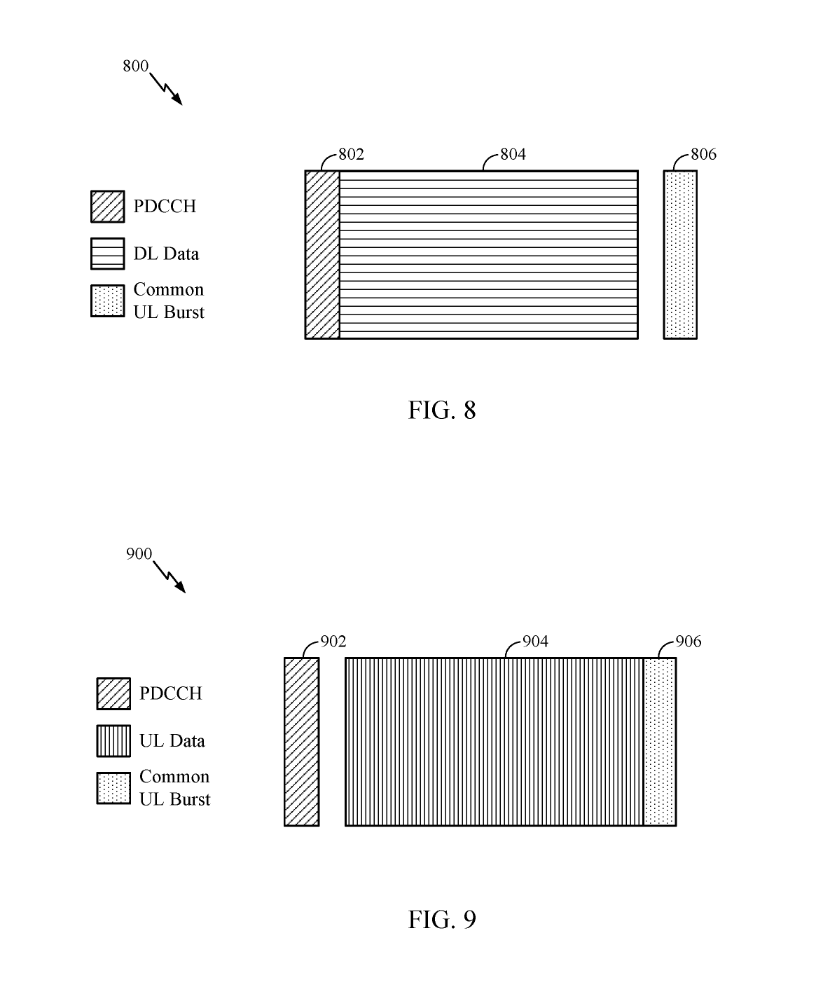

A single component carrier bandwidth of 100 MHz may be supported. NR RBs may span 12 sub-carriers with a sub-carrier bandwidth of 75 kHz over a 0.1 ms duration. Each radio frame may consist of 2 half frames, each half frame consisting of 5 subframes, with a length of 10 ms. Consequently, each subframe may have a length of 1 ms. Each subframe may indicate a link direction (i.e., DL or UL) for data transmission and the link direction for each subframe may be dynamically switched. Each subframe may include DL/UL data as well as DL/UL control data. UL and DL subframes for NR may be as described in more detail below with respect to FIGS. 8 and 9.

Beamforming may be supported and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells. Alternatively, NR may support a different air interface, other than an OFDM-based interface. NR networks may include entities such central units or distributed units

The RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity, but not used for initial access, cell selection/reselection, or handover. In some cases DCells may not transmit synchronization signals—in some case cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

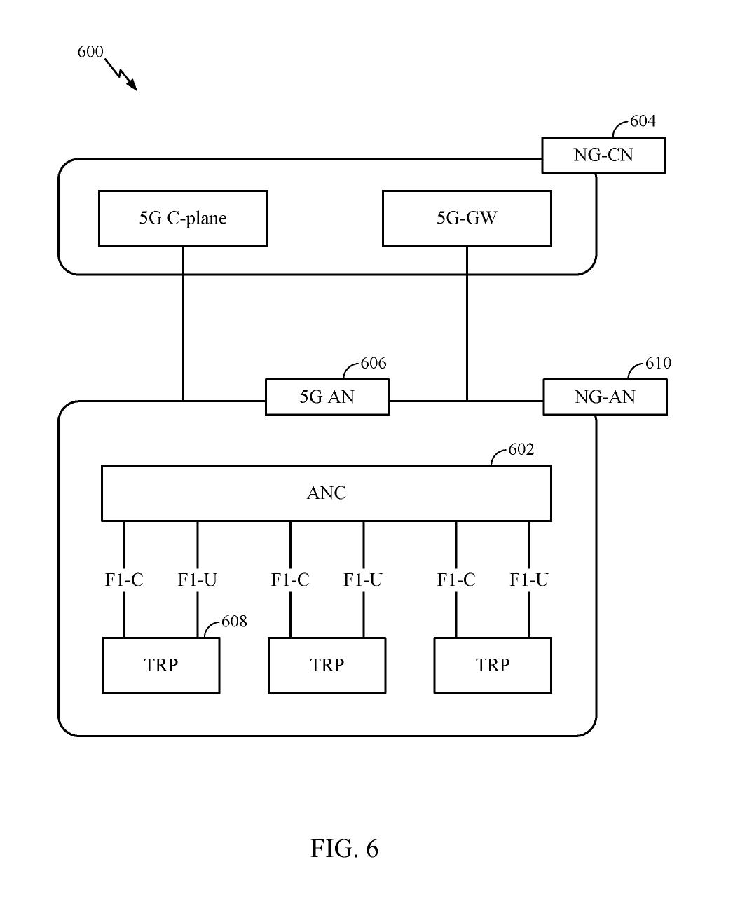

FIG. 6 illustrates an example logical architecture of a distributed RAN 600, according to aspects of the present disclosure. A 5G access node 606 may include an access node controller (ANC) 602. The ANC 602 may be a central unit (CU) of the distributed RAN 600. The backhaul interface to the next generation core network (NG-CN) 604 may terminate at the ANC 602. The backhaul interface to neighboring next generation access nodes (NG-ANs) 610 may terminate at the ANC 602. The ANC 602 may include one or more TRPs 608 (which may also be referred to as BSs, NR BSs, Node Bs, 5G NBs, APs, or some other term). As described above, a TRP may be used interchangeably with “cell.”

The TRPs 608 may be a distributed unit (DU). The TRPs may be connected to one ANC (ANC 602) or more than one ANC (not illustrated). For example, for RAN sharing, radio as a service (RaaS), and service specific AND deployments, the TRP 608 may be connected to more than one ANC. A TRP may include one or more antenna ports. The TRPs may be configured to individually (e.g., dynamic selection) or jointly (e.g., joint transmission) serve traffic to a UE.

The logical architecture may support fronthauling solutions across different deployment types. For example, the logical architecture may be based on transmit network capabilities (e.g., bandwidth, latency, and/or jitter). The logical architecture may share features and/or components with LTE. The NG-AN 610 may support dual connectivity with NR. The NG-AN 610 may share a common fronthaul for LTE and NR. The logical architecture may enable cooperation between and among TRPs 608. For example, cooperation may be preset within a TRP and/or across TRPs via the ANC 602. No inter-TRP interface may be present. The logical architecture may support a dynamic configuration of split logical function. The PDCP, RLC, and/or MAC protocols may be adaptably placed at the ANC 602 or TRP 608.

A BS may include a central unit (CU) (e.g., ANC 602) and/or one or more distributed units (e.g., one or more TRPs 608).

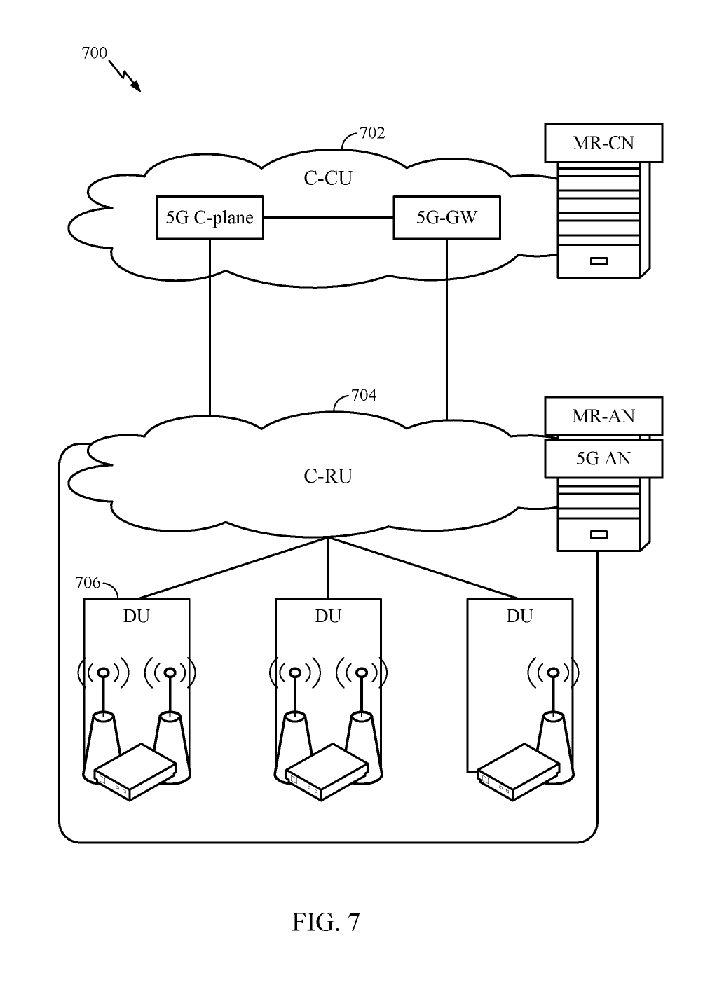

FIG. 7 illustrates an example physical architecture of a distributed RAN 700, according to aspects of the present disclosure. A centralized core network unit (C-CU) 702 may host core network functions. The C-CU 702 may be centrally deployed. C-CU functionality may be offloaded (e.g., to advanced wireless services (AWS)), in an effort to handle peak capacity.

A centralized RAN unit (C-RU) 704 may host one or more ANC functions. Optionally, the C-RU 704 may host core network functions locally. The C-RU 704 may have distributed deployment. The C-RU 704 may be close to the network edge.

A DU 706 may host one or more TRPs. The DU may be located at edges of the network with radio frequency (RF) functionality.

FIG. 8 is a diagram showing an example of a DL-centric subframe 800. The DL-centric subframe 800 may include a control portion 802. The control portion 802 may exist in the initial or beginning portion of the DL-centric subframe 800. The control portion 802 may include various scheduling information and/or control information corresponding to various portions of the DL-centric subframe 800. The control portion 802 may be a physical DL control channel (PDCCH), as shown in FIG. 8. The DL-centric subframe 800 may also include a DL data portion 804. The DL data portion 804 may be referred to as the payload of the DL-centric subframe 800. The DL data portion 804 may include the communication resources utilized to communicate DL data from the scheduling entity (e.g., UE or BS) to the subordinate entity (e.g., UE). The DL data portion 804 may be a physical DL shared channel (PDSCH).

The DL-centric subframe 800 may also include a common UL portion 806. The common UL portion 806 may be referred to as an UL burst, a common UL burst, and/or various other suitable terms. The common UL portion 806 may include feedback information corresponding to various other portions of the DL-centric subframe 800. For example, the common UL portion 806 may include feedback information corresponding to the control portion 802. Non-limiting examples of feedback information may include an ACK signal, a NACK signal, a HARQ indicator, and/or various other suitable types of information. The common UL portion 806 may include additional or alternative information, such as information pertaining to RACH procedures, scheduling requests (SRs), and various other suitable types of information. As illustrated in FIG. 8, the end of the DL data portion 804 may be separated in time from the beginning of the common UL portion 806. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric subframe 800 and alternative structures having similar features may exist without necessarily deviating from the aspects described herein.

FIG. 9 is a diagram showing an example of an UL-centric subframe 900. The UL-centric subframe 900 may include a control portion 902. The control portion 902 may exist in the initial or beginning portion of the UL-centric subframe 900. The control portion 902 in FIG. 9 may be similar to the control portion 802 described above with reference to FIG. 8. The UL-centric subframe 900 may also include an UL data portion 904. The UL data portion 904 may be referred to as the payload of the UL-centric subframe 900. The UL portion may refer to the communication resources utilized to communicate UL data from the subordinate entity (e.g., UE) to the scheduling entity (e.g., UE or BS). The control portion 902 may be a physical downlink control channel (PDCCH).

As illustrated in FIG. 9, the end of the control portion 902 may be separated in time from the beginning of the UL data portion 904. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric subframe 900 may also include a common UL portion 906. The common UL portion 906 in FIG. 9 may be similar to the common UL portion 806 described above with reference to FIG. 8. The common UL portion 906 may additional or alternative include information pertaining to channel quality indicator (CQI), sounding reference signals (SRSs), and various other suitable types of information. One of ordinary skill in the art will understand that the foregoing is merely one example of an UL-centric subframe and alternative structures having similar features may exist without necessarily deviating from the aspects described herein.

### EXAMPLE LOW POWER STATES

In the context of machine type communications (MTC) and Internet of Things (IoT) communications, UEs (e.g., such as a UE 120) may use power saving functions in which the UEs go to deep sleep (e.g., in which they do not follow any access stratum procedure). As a result, these UEs may become unreachable to the network for very long times (e.g., tens of minutes, hours, or even days). Examples of these power savings functions include extended/enhanced idle mode discontinuous reception (eDRX) and power saving mode (PSM).

These two example power saving functions have the following common characteristics: both are designed for UEs to have wakeup time windows (e.g., the paging time window (PTW) for eDRX, or the pTAU connected+active time) in a statistically distributed manner. Both of these solutions were designed for unicast service, where it is better in terms of resource utilization distribution that devices wake up at different times.

However, in the case of Multimedia Broadcast Multicast Services (MBMS), it is better for all UEs to be awake at roughly the same time for broadcast delivery. MBMS is not effective if all UEs wake up at different times. In narrowband Internet of Things (NB-IoT) and/or MTC, many devices in these modes may be highly unreachable for a long time. For example, in eDRX, a UE may be unreachable for up to a few hours. Even worse, for PSM, maximum unreachability may be up to days (e.g., ˜10 days), for example. This means potentially large delays for reconfiguration/service announcement. In particular, broadcast service announcements may need to be repeated for a very long duration of time.

### EXAMPLE POWER SAVING IN SENSOR DATA SAMPLING AND REPORTING

As noted above, collecting a wide range of sensor data with a high frequency has an adverse impact on the battery life of the device collecting the data. So, it is desirable to ensure that while collecting key sensor data in a timely manner, the data is collected in an intelligent manner so as to improve the overall battery lifetime. This may be particularly important for remotely installed devices that may need to operate unattended for extended periods of time.

Aspects of the present disclosure provide techniques that may help coordinate certain aspects of how a wireless chipset of an IoT device and an external micro-controller connected to the wireless chipset work. For example, such techniques may aim to ensure the data gathered and sent over the air (to the IoT cloud that is monitoring such data) using standards based IoT protocols, such as Lightweight Machine to Machine (LWM2M), is done so in a manner that improves the overall battery lifetime of the device.

LWM2M generally refers to a protocol developed by the Open Mobile Alliance for remote device management in the IoT and other Machine-to-Machine applications. A network environment using the LWM2M protocol consists of LWM2M Clients located on end devices, LWM2M Servers, and Objects. An LwM2M Bootstrap Server generally refers to a certain server that may be contacted by the Client during its first or every boot-up. Its purpose is to initialize the data model, including connections to regular LWM2M Servers, before first contact to such.

The Bootstrap Server communicates with the Client using a different set of commands. “Regular” LWM2M Servers maintain connections with the clients and have the ability to read from and write to the data model exposed by the clients. Any given client may be concurrently connected to more than one LwM2M Server, and each of them may have access only to a part of the whole data model. Objects each represent some different concept of data accessible via the LwM2M client. For example, separate Objects are defined for managing connections with LwM2M servers, for managing network connections, and for accessing data from various types of sensors.

By default, Notify messages are sent each time there is some change to the value of a queried path. A queried path may, for example, be a Resource, or all Resources within a given Object Instance or Object, if the Observe request was called on such higher-level path. Certain parameters may control when data is reported. For example, a Minimum Period (Pmin) value, if set to a non-zero value, will keep notifications from being sent more often than once every Pmin seconds. On the other hand, a Maximum Period (Pmax), if set, will ensure notifications are sent at least once every Pmax seconds, even if the value did not change. As will be described in greater detail below, aspects of the present disclosure may help reduce power by synchronizing Pmin and Pmax values for sensors of a certain type.

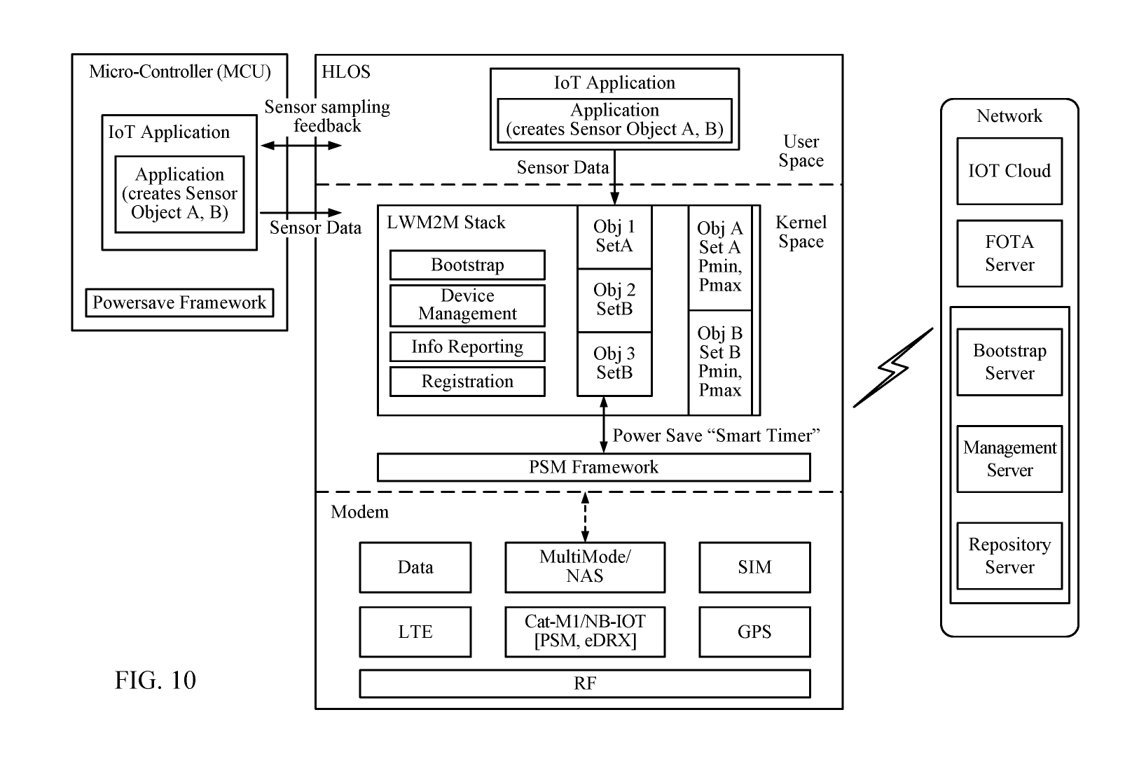

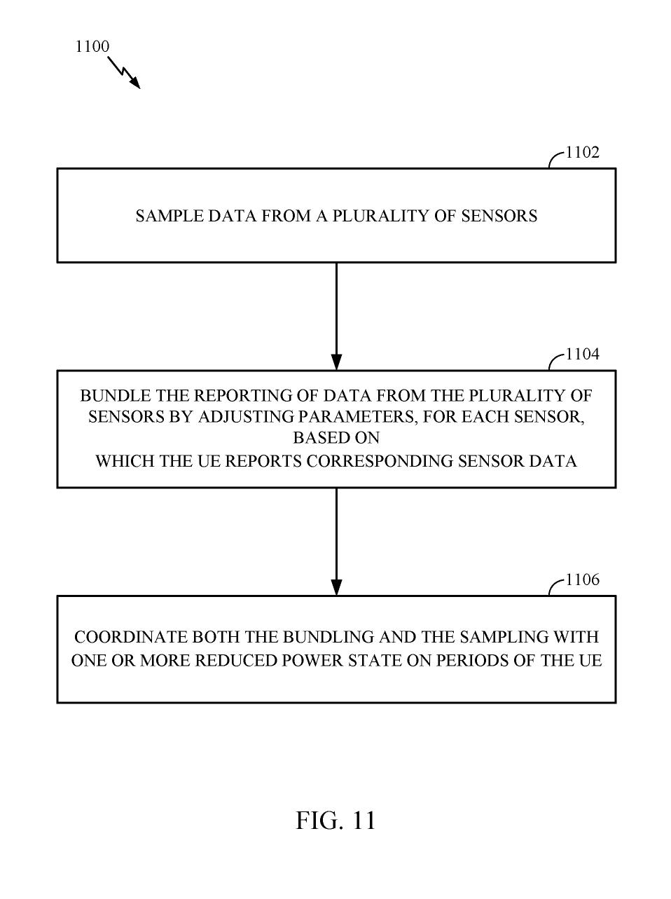

FIG. 10 illustrates an example architecture based on a wireless chipset for performing IoT based data sensing and reporting. As illustrated, an external Micro-Controller Unit (MCU) may host an IoT application that senses data and provides sensor data to a high level operating system (HLOS) on a modem. As illustrated, the HLOS may maintain an LWM2M Stack. Sensor data sampled by the MCU may be reported to a network, via the modem chip.

Modems in wireless chipsets that support Cat-M1 and NB-IOT, such as that shown in FIG. 10, typically have built-in power saving techniques such as eDRX (Extended/Enhanced Discontinuous Reception) and Power Saving Mode (PSM) based on 3GPP standards (e.g., Rel-12 and Rel-13). As noted above, eDRX allows the UE to sleep for a pre-defined period of time (e.g., as measured by a number of hyper frames of 10.24 s) before becoming available to receive traffic from the network. PSM allows the UE to negotiate (with the network) a period for which the UE would go into a deep-sleep mode. A combination of eDRX and PSM allows the UE to reduce power drawn by the chipset and thereby increase battery life.

As illustrated in FIG. 10, sensor data to be monitored from the UE is set up via the LWM2M protocol. LWM2M implements certain standard set of objects for device management from the IoT cloud. Examples of such objects defined in LWM2M OMA standard include Battery indicator, GPS location, Software management, and APN connection profile. LWM2M also allows for non-standard objects to be created by custom sensor applications that run on the chipset or on external micro-controllers.

Aspects of the present disclosure may help address power concerns on both hosted mode and host-less mode sensor applications. Hosted mode sensor applications generally refer to sensor applications running on external micro-controllers aka MCU connected to the chipset over hardware peripherals UART/USB/SPI and external sensors connected to the MCU. Host-less mode sensor applications generally refer to sensor applications running on a modem processor and external sensors connected to the chipset (e.g., over a UART/USB/SPI or other type bus connection). When a new custom sensor object is created by the application (e.g., running on the MCU or modem processor), the LWM2M framework advertises all the newly created sensor objects and the standard objects it supports to a bootstrap sever in the IoT cloud. Once the access control is set up for these newly created objects, the cloud servers (in the LWM2M cloud) are assigned to monitor the corresponding sensor data.

As noted above, aspects of the present disclosure may help reduce power consumption by coordinating both the sampling of sensor data and the bundled reporting of sensor data with one or more reduced power state periods of the UE (e.g., PSM and/or eDRX periods).

FIG. 11 illustrates example operations 1100 that may be performed by a UE (e.g., an IoT device configured to remotely monitor and report sensor data).

Operations 1100 begin, at 1102, by sampling data from a plurality of sensors. At 1104, the UE bundles reporting of data from the plurality of sensors by adjusting parameters, for each sensor, based on which the UE reports corresponding sensor data. At 1106, the UE coordinates both the bundling and the sampling with one or more reduced power state on periods of the UE.

FIG. 12 illustrates example operations 1200 that may be performed by a network entity (e.g., by a bootstrap server and/or other entity in a LWM2M cloud), to configure a UE to operate in accordance with operations 1100 described above.

Operations 1200 begin, at 1202, by identifying a first set of sensors for which a user equipment (UE) is allowed to adjust parameters based on which the UE reports corresponding sensor data. At 1204, the network entity configures the UE for sampling data from a plurality of sensors including the first set of sensors, wherein the configuring includes providing information to the UE regarding the first set of sensors.

To accomplish one aspect of the present disclosure, the bootstrap server may be allowed to specify (e.g., upon custom object creation and initial bootstrap) certain monitoring parameters for each set of sensor data collected keeping in mind the power drawn on the UE during sensor data monitoring. A Typical LWM2M Observe mechanism set up for sensor data monitoring provides parameters (e.g., PMin/PMax) based on which UE reports sensor data. One of the key issues is that different sensor data can be set up with different PMin/PMax parameters which may cause the UE could wake up at random times (if the PMin/PMax parameters are not synchronized) to report sensor data to the IoT cloud.

According to certain aspects of the present disclosure, the bootstrap server may be allowed to categorize the sensor data into two different groups (or buckets). For a first set of sensor data in the first group, a UE may be allowed to be flexible to bundle sensor data reporting by synchronizing the PMin/PMax parameters for all of the sensor data in that bucket. For a second set of data in the second group, certain must-have data may be included, which may not be allowed to be synchronized based on PMin/PMax parameters, but the UE may be able to further optimize sensor data reporting by piggy-backing this second group of data when a data reporting channel is already setup to report bundled data in the first group.

For example, a UE may be configured to optimizer power consumption by obtaining information regarding the data in the first and second sets and adjusting parameters using the obtained information. For example, a UE may be configured to take into consideration reporting parameters for both the first and second sets of sensors when setting wake up times for the reduced power state on periods (e.g., controlling when a controller wakes up to sample data, based on when the sampled sensor data can be bundled in a report with other sensor data).

Sensor applications running on the MCU or modem processor may be required to become PSM-Aware and take into account the PMin/PMax parameters for both the first and the second sets of data as specified above before specifying the wake up time for a PSM framework. By enabling bundling of sensor data of the first set and optimizing reporting of data in the second set, the sensor applications may allocate a smart timer to the PSM framework, thereby optimizing the overall chipset wake up times. Further, sensor applications have the flexibility to override the smart timer to wake up the UE from PSM, for example, in cases of an urgent need to report must-have data from the second set.

Various optimizations to the techniques described above may be added in some cases. One example takes advantage of opportunities when a UE may be forced to wake up. For example, a UE may be configured to not only report data in the second set whenever it is ready to be reported (making use of the data channel set up due to data reporting the first set), but also to report data in the first set when the UE is forced to wake up from PSM (before the wakeup timer expires) to report data in the second set.

In case of a hosted mode of operation, the sensor application running on an external MCU will typically have the facility to wake up the chipset processor (e.g., via a general purpose IO-GPIO input). For example, the sensor application may wake up the chipset in case of data in the second set before sending any data over the hardware interconnect. Additionally, again referring to FIG. 10, feedback can be provided to the MCU regarding what data can be bundled at sampling time in order to further save power on the overall device (by way of MCU now waking up not on sampling every data item but could consolidating sampling (and wake up times) based on data that can be bundled.

Examples of possible advantages and benefits of the techniques described herein include overall power gains of not only the chipset but also the MCU. By categorizing sensor data (from the LWM2M cloud) into first and second data sets, as described above, the sensor application running on either the modem processor or on the external MCU could be made smarter in regards to how data is collected from sensors and transmitted over the air, by aligning sampling and/or bundling of the data with the overall wake up time frame of the UE. Sensor data collection from external sensors may also be optimized based on bundling of data in the first set and selective piggy-backing of sensor data collected for the second set.

By adopting the techniques described herein, power savings may be optimized, for example, when both eDRX and PSM are enabled on the modem chipset and power optimized behavior is enabled on the MCU.

As used herein, a phrase referring to “at least one of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “identifying” encompasses a wide variety of actions. For example, “identifying” may include calculating, computing, processing, deriving, investigating, looking up (e.g., looking up in a table, a database or another data structure), ascertaining and the like. Also, “identifying” may include receiving (e.g., receiving information), accessing (e.g., accessing data in a memory) and the like. Also, “identifying” may include resolving, selecting, choosing, establishing and the like.

In some cases, rather than actually communicating a frame, a device may have an interface to communicate a frame for transmission or reception. For example, a processor may output a frame, via a bus interface, to an RF front end for transmission. Similarly, rather than actually receiving a frame, a device may have an interface to obtain a frame received from another device. For example, a processor may obtain (or receive) a frame, via a bus interface, from an RF front end for transmission.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in Figures, those operations may be performed by any suitable corresponding counterpart means-plus-function components.

For example, means for sampling, means for bundling, means for reporting, means for coordinating, means for obtaining, means for including, means for taking into consideration, means for configuring, means for providing, means for adjusting, means for identifying, means for determining, means for transmitting, means for receiving, means for sending, means for comparing, means for prioritizing, means for assigning, means for allocating, means for rejecting, means for restricting, means for increasing, and/or means for decreasing may include one or more processors/controllers, transmitters, receivers, antennas, and/or other modules, components, or elements of user equipment 120 and/or base station 110 illustrated in FIG. 2 and/or another network entity.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or combinations thereof.

Those of skill would further appreciate that the various illustrative logical blocks, modules, circuits, and algorithm steps described in connection with the disclosure herein may be implemented as electronic hardware, software, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination thereof. A software module may reside in RAM memory, flash memory, ROM memory, EPROM memory, EEPROM memory, phase change memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, or combinations thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD/DVD or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for wireless communications by a user equipment (UE), comprising:
sampling data from a plurality of sensors;
bundling reporting of data from the plurality of sensors by adjusting parameters, for each sensor, based on which the UE reports corresponding sensor data; and
coordinating both the bundling and the sampling with one or more reduced power state on periods of the UE.

2. The method of claim 1, wherein the one or more reduced power state on periods comprise on periods of at least one of: power savings mode (PSM) on periods or enhanced discontinuous reception (eDRX) on periods.

3. The method of claim 1, wherein adjusting the parameters comprises synchronizing, for at least some of the sensors, at least one of:
parameters for a minimum period (Pmin) for reporting sensor data; or
parameters for a maximum period (Pmax) for reporting sensor data.

4. The method of claim 1, further comprising:
obtaining information indicating a first set of sensors for which the UE is allowed to adjust the parameters based on which the UE reports the corresponding sensor data.

5. The method of claim 4, wherein the information is obtained via a bootstrap server.

6. The method of claim 4, further comprising:
including data for a second set of one or more sensors, for which the UE is not allowed to adjust the parameters based on which the UE reports the corresponding sensor data, when reporting data for the first set of sensors.

7. The method of claim 6, wherein coordinating both the bundling and the sampling with reduced power state on periods of the UE comprises:
taking into consideration reporting parameters for both the first and second sets of sensors when setting wake up times for the reduced power state on periods.

8. The method of claim 1, wherein coordinating both the bundling and the sampling comprises controlling when a controller wakes up to sample data, based on when the sampled sensor data can be bundled in a report with other sensor data.

9. A method for wireless communications by a network entity, comprising:
identifying a first set of sensors for which a user equipment (UE) is allowed to adjust parameters based on which the UE reports corresponding sensor data; and
configuring the UE for sampling data from a plurality of sensors including the first set of sensors, wherein the configuring includes providing information to the UE regarding the first set of sensors.

10. The method of claim 9, wherein the configuring is performed via a bootstrap server.

11. The method of claim 9, further comprising:
providing information to the UE regarding a second set of one or more sensors, for which the UE is not allowed to adjust the parameters based on which the UE reports the corresponding sensor data.

12. The method of claim 11, further comprising:
receiving a report, from the UE, of sensor data for at least some of the first set of sensors.

13. The method of claim 12, wherein:
the report also includes sensor data for at least some of the second set of sensors.

14. An apparatus for wireless communications by a user equipment (UE), comprising:
means for sampling data from a plurality of sensors;
means for bundling reporting of data from the plurality of sensors by adjusting parameters, for each sensor, based on which the UE reports corresponding sensor data; and
means for coordinating both the bundling and the sampling with one or more reduced power state on periods of the UE.

15. The apparatus of claim 14, wherein the one or more reduced power state on periods comprise on periods of at least one of: power savings mode (PSM) on periods or enhanced discontinuous reception (eDRX) on periods.

16. The apparatus of claim 14, wherein the means for adjusting the parameters comprises means for synchronizing, for at least some of the sensors, at least one of:
parameters for a minimum period (Pmin) for reporting sensor data; or
parameters for a maximum period (Pmax) for reporting sensor data.

17. The apparatus of claim 14, further comprising:
means for obtaining information indicating a first set of sensors for which the UE is allowed to adjust the parameters based on which the UE reports the corresponding sensor data.

18. The apparatus of claim 17, wherein the information is obtained via a bootstrap server.

19. The apparatus of claim 17, further comprising:
means for including data for a second set of one or more sensors, for which the UE is not allowed to adjust the parameters based on which the UE reports the corresponding sensor data, when reporting data for the first set of sensors.

20. The apparatus of claim 19, wherein the means for coordinating both the bundling and the sampling with reduced power state on periods of the UE comprises:
means for taking into consideration reporting parameters for both the first and second sets of sensors when setting wake up times for the reduced power state on periods.

21. The apparatus of claim 14, wherein the means for coordinating both the bundling and the sampling comprises means for controlling when a controller wakes up to sample data, based on when the sampled sensor data can be bundled in a report with other sensor data.

22. An apparatus for wireless communications by a network entity, comprising:
means for identifying a first set of sensors for which a user equipment (UE) is allowed to adjust parameters based on which the UE reports corresponding sensor data; and
means for configuring the UE for sampling data from a plurality of sensors including the first set of sensors, wherein the configuring includes providing information to the UE regarding the first set of sensors.

23. The apparatus of claim 22, wherein the configuring is performed via a bootstrap server.

24. The apparatus of claim 22, further comprising:
means for providing information to the UE regarding a second set of one or more sensors, for which the UE is not allowed to adjust the parameters based on which the UE reports the corresponding sensor data.

25. The apparatus of claim 24, further comprising:
means for receiving a report, from the UE, of sensor data for at least some of the first set of sensors.

26. The apparatus of claim 25, wherein:
the report also includes sensor data for at least some of the second set of sensors.
